(19) United States
(12) Patent Application Publication
(10) Pub. No.: US 2008/0272035 A1
(43) Pub. Date: Nov. 6, 2008

(54) System for Water Treatment

(75) Inventors: John Fox, Queensland (AU); Errol O'Brien, Queensland (AU)

Correspondence Address: TRASK BRITT, P.O. BOX 2550, SALT LAKE CITY, UT, 84110, US

(73) Assignee: BUSHWATER HOLDINGS PTY LTD, Coolum Beach (AU)

(21) Appl. No.: 10/584,358

(22) PCT Filed: Dec. 23, 2004
(86) PCT No.: PCT/AU04/01820

§ 371 Date: Oct. 16, 2007

(30) Foreign Application Priority Data
Dec. 24, 2003 (AU) 2003907125

(51) Int. Cl. C02F 9/00; C02F 9/14

(52) U.S. Cl. 210/110; 210/195.2; 210/97

(57) ABSTRACT

A system for water treatment comprising a first treatment area for receiving waste water and aerating the waste water to enhance aerobic bacterial treatment of waste water, a second treatment area for receiving waste water from the first treatment area and circulating waste water within it to enhance bacterial treatment of waste water, a third treatment area configured to receive waste water from the second treatment area and including a filter having at least one membrane for filtering the waste water to substantially remove particulate matter of a predetermined size, an outlet connected to the filter and configured to output filtered waste water from the filter and a transfer means for transferring waste water from the third treatment area to the first treatment area.

### FIELD OF THE INVENTION

The present invention relates to water treatment systems and in particular smaller treatment plants such as those used in domestic applications.

### BACKGROUND OF THE INVENTION

Existing home sewage treatment plants are limited in their application to domestic dwellings on larger blocks of land. This is because the treated water output from the plants is still of inadequate quality to meet regulatory requirements. Therefore in large housing developments on small blocks of land the treated water which is output from a larger number of domestic treatment plants can be a health hazard if there is inadequate space.

There is a need therefore to produce a superior type of water treatment system which has improved treated water output so as to enable usage of the water treatment system in a more highly densified population environment.

The present invention provides a system for water treatment which may have benefits in producing superior quality treated water over a common variety water treatment system with a basic anaerobic and aerobic treatment tank.

### SUMMARY OF THE INVENTION

According to the present invention there is provided a system for water treatment comprising a first treatment area for receiving waste water and aerating the waste water to enhance aerobic bacterial treatment of waste water, a second treatment area for receiving waste water from the first treatment area and circulating waste water within it to enhance anoxic/anaerobic bacterial treatment of waste water, a third treatment area configured to receive waste water from the second treatment area and including a filter having at least one membrane for filtering the waste water to substantially remove particulate matter of a predetermined size, an outlet connected to the filter and configured to output filtered waste water from the filter and a transfer means for transferring waste water from the third treatment area to the first treatment area.

Preferably the transfer means transfers waste water directly from the third treatment area to the first treatment area.

According to one embodiment the transfer means transfers waste water indirectly from the third to the first transfer area.

It is preferred that the transfer means includes at least one conduit.

The first treatment area may include a chamber.

The second treatment area may include a second chamber.

The chambers may be located inside a large tank.

Preferably the first treatment area includes a circulation means for circulating waste water within the first treatment area.

The transfer means may comprise an opening in a common wall between the first and third treatment areas.

Preferably the opening includes an insert.

The insert may be threaded so as to screw into the opening.

Preferably the opening has a reducing width to reduce blockage.

Preferably the opening is located between high and lower water levels in the third treatment area.

The opening is preferably located above the high water level in the first treatment area.

The transfer means may comprise a pipe connecting the third and first treatment areas.

It is preferred that the system includes first pressure means for transferring waste water from the first to second treatment areas.

Preferably the system includes second pressure means for transferring waste water from the second to the third treatment area.

The system may include a third pressure means for transferring waste water from the third to the first treatment area.

According to one embodiment the system includes a fourth treatment area and the transfer means is configured to transfer waste from the third treatment area to the fourth treatment area.

Preferably waste water is transferred from the fourth treatment area to the first treatment area.

The transfer means preferably includes one or more conduits connecting the third treatment area with the first treatment area.

Preferably the third transfer area includes a circulation means for circulating waste water within it.

The first treatment area may be connected to the second treatment area through a first feed means.

The feed means may include a conduit.

The first feed means may include a pump.

The first feed means may include a gravity feed system.

The second treatment area preferably is connected to the third treatment area through a second feed means.

The second feed means may have one or more features of the first feed means.

The transfer means may include a pump for pumping waste water from the third treatment area to the fourth treatment area.

The transfer means may include a pump for pumping waste water from the fourth treatment area to the first treatment area.

The fourth treatment area may include a circulation means for circulating waste water within the fourth treatment area.

The system may include one or more additional treatment areas connected directly or indirectly to the fourth or third treatment areas.

The first treatment area may include a first tank.

The second treatment area may include a second tank.

The third treatment area may include a third tank.

The fourth treatment area preferably includes a chamber located within the first treatment area.

According an alternative embodiment the fourth treatment area comprises a tank separate from the third and first treatment areas.

According to one embodiment the first treatment area is located between the second and third treatment areas.

The first treatment area may be a partitioned area in a large tank.

The second and third treatment areas may be partitioned areas within the same large tank.

Preferably the second treatment area includes a sludge circulation means.

The second treatment area may include at least one pipe which draws sludge from the bottom of the second treatment area and outputs it at a top end of the second treatment area.

The sludge circulation means may include a plurality of pipes.

The plurality of pipes may be vertically arranged.

According to one embodiment of the invention the transfer means includes a conduit between the third and first treatment areas.

The system preferably includes a control means for controlling waste water entering and leaving the system to maintain the waste water level between upper and lower limits.

The control means preferably includes a float switch.

The fourth treatment area may include a partitioned chamber located in the first treatment area.

The partitioned chamber may include an opening in a bottom surface.

Preferably the filter comprises a plurality of membranes.

According to one embodiment there is provided a feedback pipe from the third treatment area to the second treatment area.

Preferably the inlet of the feedback pipe is located at a bottom of third treatment area.

The second treatment area preferably maintains a substantially homogenous sludge waste water mix.

The first treatment area preferably maintains a substantially homogenous sludge waste water mix.

The system preferably includes an outlet for transferring waste water from the filter.

It is preferred that water passing through the outlet is fed by a head of waste water above the filter.

It is preferred that the water level within the third treatment area is maintained between the upper and lower limits.

It is to be understood that, if any prior art publication is referred to herein, such reference does not constitute an admission that the publication forms a part of the common general knowledge in the art, in Australia or in any other country.

### BRIEF DESCRIPTION OF THE DRAWINGS

A preferred embodiment of the present invention will now be described by way of example only with reference to the accompanying drawings in which:

FIG. 1 shows a schematic diagram of a water treatment system according to a preferred embodiment of the present invention;

FIG. 2 shows a cross-sectional view of a self-cleaning hole used in the preferred embodiment of the present invention;

FIG. 3 shows a graph used for calculating a position of a bleed hole used in the preferred embodiment of the invention; and

FIG. 4 shows examples of orifices and how the different shapes of the orifices affect the constant K.

### DETAILED DESCRIPTION OF THE DRAWINGS

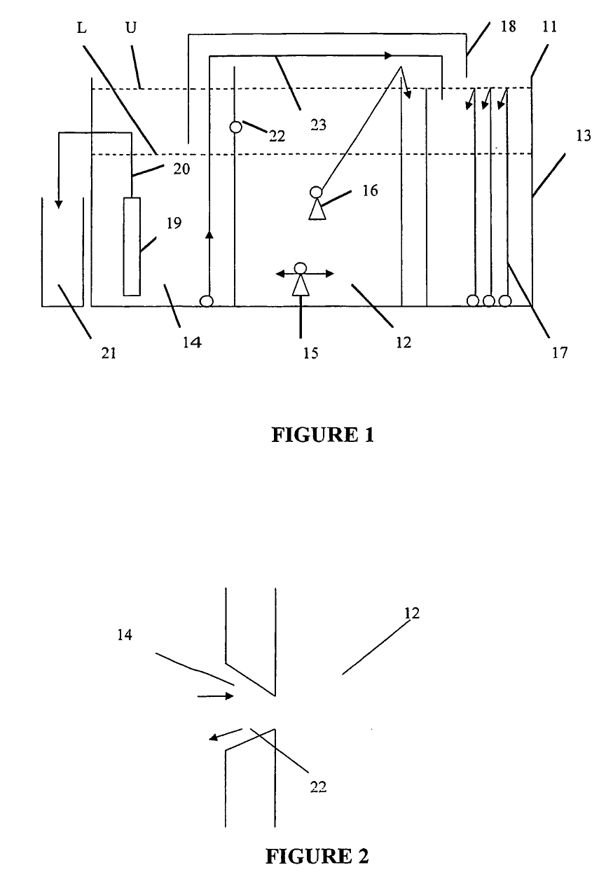

The preferred embodiment of the invention shown in FIG. 1 consists of a circular water tank 11 which is divided into a central primary treatment area 12, a secondary treatment area 13 and a tertiary treatment area 14.

Although the secondary and tertiary treatment areas are shown as being on either sides of the primary treatment area they maybe situated close to each other.

Waste water to be treated is fed into the primary treatment area and typically includes solid particulate matter. A circulating pump 15 preferably a centrifugal submersible with open style impeller and integral float switch is located in the primary chamber to continually circulate waste water and particulate matter. Emulsifying aerators are also located within the primary chamber and are located such that water flow from each unit is in the same direction but at 180° to each other.

The circulating pump and emulsifier aerators ensure maximum aerobic bacterial activation within the primary chamber.

A controller connected to a float switch ensures the level of waste water within the tank does not fall below a minimum limit. This minimum limit is in part determined so as to ensure that the circulating pump does not dry run.

Waste water from the primary chamber is pumped to the secondary chamber 13 for anoxic and where possible anaerobic bacterial treatment. This secondary treatment area 13 may be in the form of a recycle tank containing pipe work for the inlet of waste water is pumped from the primary treatment tank.

The inlet flow to the secondary treatment area is from top to bottom. The recycle tank contains three airlift pumps that are constructed from PVC plastic that are at 90° to each other.

The operation of the recycle tank air lift pumps is to lift sludge from the bottom of the recycle tank to the top where the air and water discharges via a T-fitting located internal to the tank and below the top opening.

It is preferred that the air lift pumps include vertical conduits which extend from the upper waste water level limit to the bottom of the tank.

The recycle tank also contains another PVC pipe that runs from top to bottom of the tank and directs sludge flow to the bottom of the recycle tank.

Waste water from the recycle tank 13 is transferred to the tertiary treatment tank 14 by 50 mm diameter flexible pipe that is located close to the top of both the recycle tank and the tertiary treatment tank 14 with a hydraulic fall to the tertiary treatment tank.

In general operation the recycle tank always has a waste water height such that the level is at the same level as the recycle tank outlet.

The tertiary treatment area 14 is in the form of a membrane tank that is located in the main tank forming the primary treatment area.

The membrane tank 14 contains a membrane bioreactor assembly 19 that is submerged in activated sludge of higher concentration than the activated sludge contained in the primary treatment area 12. The membrane bioreactor consists of a submerged membrane filter unit typically having membrane cartridges. The membrane unit 19 is able to sit at the bottom of the tertiary treatment area 14 and is connected through pipework 20 through an opening in the side wall of the tank 11 to a treated water tank 21.

The membrane unit serves as a final filtering assembly which is able to restrict passage of sludge or micro-organisms into the treatment tank 21.

The membrane unit is preferably supported by plastic or stainless steel stays. One end of the stays is attached to the membrane unit and the other end is attached to the top of the treatment tank 14. This serves to support the membrane unit in a vertical position and at a nominated depth of submergence.

In addition to the above the membrane tank 14 has an air entry pipe, a chlorine membrane cleaning pipe and a water wash pipe extending downwards from the top of the membrane tank and connected to the membrane unit.

Furthermore in addition to the above a waste water opening 22 or bleed hole is provided through the common wall separating the membrane tank from the primary treatment tank 11 preferably between high and low level waste water limits.

This opening 22 enables particulate matter including sludge to pass with the waste water back into the primary treatment tank 11. This assists with maintaining the concentration of sludge in the membrane tank 14 at a preferred concentration level higher than that in the primary and secondary tanks 12 and 13.

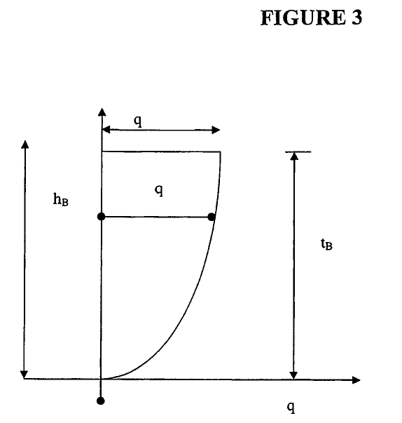

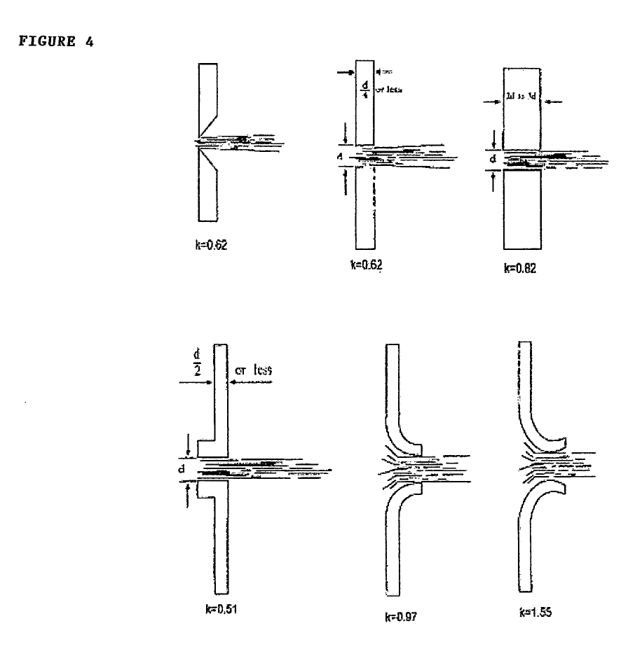

The distance of the opening 22 below the upper waste water level can be calculated by a mathematical formula which links the distance of the hole from the water level (water head above bottom of bleed hole) (in millimetres) to the rate of fall of the water level in the membrane tank 14 in FIG. 1, the area under the q/t curve shown in FIG. 3, where q is the flow rate through opening 22 in the membrane tank 14 and t is the period of time taken for the water level to drop to the level of the opening 22, as well as the area of the opening 22 and the bleed hole form factor k_{B} which is a constant based on the type of hole which is desired.

The calculations used to derive a formula for calculating the distance of the opening 22 or bleed hole from the surface of the fluid in tank 14 are as follows with reference to FIG. 3.
q_{B}=rate of flow
   =A_{B}·V_{B}·K_{B}
A_{B}=area of bleed hole
V_{B}=velocity of bleed flow
K_{B}=bleed hole form factor

Assume: 0.7

$${V}_{M} = rate of fall of membrane tank surface mm \text{/} sec )$$

$${q}_{M} = flow rate through membranes ( 1 \text{/} sec )$$

$${Q}_{M} = flow through membrane / pump cycle ( 1 )$$

$${A}_{M} = section area of membrane tank ( {m}^{2} )$$

$${D}_{M} = side dimension of square tank ( m )$$

$${D}_{B} = diameter of bleed hole ( mm )$$

$${A}_{B} = \frac{π {D}_{B}^{2}}{4} ( {mm}^{2} )$$

$${h}_{B} = water head above bottom of bleed hole ( mm ) \\ \begin{matrix}{t}_{B} = time for water surface to fall below bleed hole ( sec ) \\ = {h}_{B} / {V}_{M}\end{matrix} \\ {V}_{M} + {q}_{M} / {A}_{M} \\ {V}_{B} = \sqrt{2 g \cdot {h}_{B}} \\ \begin{matrix}{q}_{B} = {A}_{B} \cdot {V}_{B} \cdot K \\ = \frac{π {D}_{{B}^{2}}}{4} \cdot \sqrt{2 {gh}_{B}} \cdot 0.7\end{matrix} \\ {Q}_{B} = area under the q / t curve above$$

As a parabola, the area under the curve:

$${Q}_{B} = 2 / 3 ( width \times height )$$

$$2 / 3 {q}_{B} \cdot tB$$

$$i . e . {t}_{B} = \frac{3}{2} \frac{{Q}_{B}}{{q}_{B}} = \frac{3}{2} \frac{{Q}_{B} ( known )}{{A}_{B} \cdot {V}_{B} \cdot K}$$

$${h}_{B} = {t}_{B} \cdot {V}_{M} = \frac{3}{2} \frac{{Q}_{B} \cdot {V}_{M}}{{q}_{B}} = \frac{3}{2} \frac{{Q}_{B} \cdot {V}_{M}}{{A}_{B} \cdot {V}_{B} \cdot K}$$

$${V}_{B} = \sqrt{2 {gh}_{B}}$$

$$i . e . hB = \frac{3}{2} \frac{{Q}_{B} \cdot {V}_{M}}{{A}_{B} \cdot K \cdot \sqrt{2 {gh}_{B}}}$$

$$i . e . {h}_{B} \sqrt{{h}_{B}} = \frac{3}{2} \frac{{Q}_{B} \cdot {V}_{M}}{{A}_{B} K \sqrt{2 g}} \\ ∴ {h}_{B} = {( \frac{3}{2} \frac{{Q}_{B} \cdot {V}_{M}}{AK \sqrt{2 g}} )}^{\frac{2}{3}}$$

The formula given for h_{B} will vary slightly based on flow in rates of waste water into the membrane tank 14 and out of the tank 13. Normally this is a gravity feed, but may also be a pumping feed.

Based on the above it is possible to choose a height for the hole 22 depending on other variables occurring within the system. Therefore according to one embodiment a series of holes 22 may be provided at different heights between tanks 12 and 14. Each of the holes except for one may be covered and a controlling mechanism may be provided to alternately open a different hole and close the remaining holes.

According to one embodiment a slot may be provided in the wall between tanks 14 and 12 and a sliding mechanism with a hole may be provided which is controlled by a servo motor with a linkage arm. The servo motor would be located above the maximum water level of the system and would be controlled to move the hole up and down to a desired position based on expected usage of the overall system for example.

In an alternative embodiment a small pipe may be used instead of the opening 22 in order to interconnect tanks 12 and 14. The pipe may be telescopic so that the inlet/outlet to tank 11 may be varied by sliding it up and down to the desired position.

Other embodiments are also included in the present application in which the position of the hole may be varied with regard to the fluid level of the system. Typically this would be the waste water level of the system.

It is preferred that a data processor is used to control the height of the bleed hole 22 with respect to the water level. For example values for Q_{B}, V_{M}, A_{B} and K_{B} may be selected and the value for h_{B} can then be calculated and the opening 22 can be set to that level. If it is expected that there will be an increased usage of the system then concentration levels of matter within the tanks will go up, i.e. B.O.D levels. The value for h_{B} may then need to be increased to ensure that fluid is passed back into tank 11 more quickly.

It should be noted that the values for the constant K_{B} will be dependent upon the type of hole interconnecting tanks 14 and 12. For example if the hole is in the form of a small length of pipe the value for K_{B} may be lower.

As shown in FIG. 2 the opening 22 may be contoured to have a reducing diameter from the membrane tank 14 to the primary treatment tank 11. This helps provide a self-cleaning aspect to the hole and reduces problems associated with blocking of the hole.

According to one embodiment the hole may also be provided with a tubular insert which is screwed into a threaded hole created in the common wall of the membrane and primary tanks 14 and 12.

The membrane tank 14 has a float switch (No. 1) which is attached to the top of the tank 11. This float switch (not shown) hangs down into the membrane tank and switches on and off the primary tank feed pump. This float switch (No. 1) serves to maintain the water level in the membrane tank 14 between the upper water level limit U and the lower water level limit L.

The feed pump in the primary chamber 12 then pumps liquid to the recycle tank 13 which overflows to fill the membrane tank 14. The feed pump is submersed at a particular depth so as to maintain a minimum of 2,000 litres in the primary tank 11.

Another float switch (No. 2) is located above the feed pump and is set so that a minimum of 2,000 litres of tank volume is available both above and below the float switch No. 2. An additional float switch (No. 3) is located above float switch No. 2 at a height of approximately 300 mm above float switch no. 2. This float switch is used to activate the alarm system to indicate the upper water level has been reached.

The water membrane tank 14 has a lower limit L to provide sufficient height of water above the membrane unit 19 to give transmembrane pressure sufficient to activate the membrane bioreactor. The float switch No. 1 in this tank ensures that the level does not drop below level L by controlling the feed pump.

The water membrane tank 14 also has an airlift pump that transfers liquid from the membrane tank 14 through conduit 23 to the recycle tank 13.

The opening 22 between the membrane tank 14 and primary treatment tank 11 may be replaced by a conduit and a pump which pumps waste water into the primary treatment tank 11.

According to another embodiment a further treatment tank or tanks may be added to the system so that waste water can be pumped out of the membrane tank so as to reduce the level of sludge therein. Water in these final treatment tank(s) can then be pumped back into the primary treatment tank 11. Alternatively a gravity feed can be used for transferral of the waste water into the primary treatment tank.

According to another variation of the invention the tertiary treatment area is located within the primary treatment tank and may include a series of baffles which are located in close proximity to the opening 22 to segregate water initially entering the primary treatment tank from the membrane tank 14. Alternatively a small tank may be located inside the primary tank and the opening may include a conduit feeding straight into this tank. The bottom of the tank may be perforated to allow waste water to travel into the rest of the primary treatment area.

According to another embodiment the primary treatment tank may include an inlet baffle that directs inlet water flow downwards towards the base of this tank. Located internal to the baffle may be a metal strainer that is constructed of perforated metal with approximately 3 mm holes covering the majority of the surface of the strainer.

According to another embodiment of the present invention a plurality of holes may be provided in the common wall separating the membrane tank 14 from the primary treatment tank 11.

The membrane tank 14 preferably has a circulation pump which serves to circulate activated sludge within the membrane tank 14. The same or an additional cleaning or circulating device may be used to periodically wash down the membrane unit 19.

With the system described above the treated water entering the treatment tank 21 has improved characteristics over more basic domestic treatment plants.

By having a separate membrane tank it is possible to utilise a membrane unit. The membrane tank provides sufficient height of water above the membrane unit to give transmembrane pressure sufficient to actuate the membrane bioreactor. In addition the recycle tank is able to maintain an inventory of oxygen limited sludge that provides sludge to the membrane tank 14. Furthermore the provision of a membrane bioreactor makes it possible to treat polluted water such as grey water, black water, sewerage and some industrial waste to a level such that reuse and recycling is possible.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A system for water treatment comprising a first treatment area for receiving waste water and aerating the waste water to enhance aerobic bacterial treatment of waste water, a second treatment area for receiving waste water from the first treatment area and circulating waste water within it to enhance bacterial treatment of waste water, a third treatment area configured to receive waste water from the second treatment area and including a filter having at least one membrane for filtering the waste water to substantially remove particulate matter of a predetermined size, an outlet connected to the filter and configured to output filtered waste water from the filter and a transfer means for transferring waste water from the third treatment area to the first treatment area.

2. The system as claimed in claim 1 wherein the transfer means transfers waste water directly from the first treatment area to the third treatment area.

3. The system as claimed in claim 1 wherein the transfer means transfers waste water indirectly from the third to the first transfer area.

4. The system as claimed in claim 1 wherein the transfer means includes at least one conduit.

5. The system as claimed in claim 1 wherein the first treatment area includes a chamber.

6. The system as claimed in claim 5 wherein the second treatment area may include a second chamber.

7. The system as claimed in claim 1 wherein the transfer means comprises an opening in a common wall between the first and third treatment areas.

8. The system as claimed in claim 1 wherein the transfer means includes a plurality of openings each located at a different level with respect to the upper liquid level in the system.

9. The system as claimed in claim 1 wherein the transfer means comprises an opening in the wall between the first and third treatment areas, which opening can be changed in height.

10. The system as claimed in claim 4 wherein the conduit has an outlet in the first treatment area, which outlet comprises an opening which has a distance from the upper fluid level in the system which is able to be changed.

11. The system as claimed in claim 7 comprising a controller for controlling the level of the opening.

12. The system as claimed in claim 11 wherein the controller comprises a data processor which is able to control the distance h_{B} of the opening from the upper water level in the system based on the formula
$${h}_{B} = {( \frac{3}{2} \frac{{Q}_{B} \cdot {V}_{M}}{AK \sqrt{2 g}} )}^{\frac{2}{3}}$$
Q_{B}=⅔(q_{B}×t_{B})
q_{B}=the rate of flow through the opening
t_{B}=the time for the fluid surface to fall below the opening
V_{M}=the rate of fall of fluid level in the third treatment area
A=the cross sectional area of the opening
K=the bleed hole form factor (of the opening)
g=the gravitational constant.

13. The system as claimed in claim 1 wherein the transfer means comprises a hole between the first and third treatment areas, which opening comprises a bleed hole having a water head value above the bottom of the bleed hole which is calculated by the formula:
$${h}_{B} = {( \frac{3}{2} \frac{{Q}_{B} \cdot {V}_{M}}{AK \sqrt{2 g}} )}^{\frac{2}{3}}$$
wherein h_{B}=the water head above the bottom of the opening, Q_{B}=⅔(q_{B}×t_{B})
q_{B}=the rate of flow through the opening
t_{B}=the time for the fluid surface to fall below the opening
Vₘ=the rate of fall of fluid level in the third treatment area
A=the cross sectional area of the opening
K=the bleed hole form factor (of the opening)
g=the gravitational constant.

14. The system as claimed in claim 1 wherein the first treatment area includes a circulation means for circulating waste water within the first treatment area.

15. The system as claimed in claim 14 wherein the opening includes an insert which is able to reduce the size of the opening.

16. The system as claimed in claim 7 wherein the opening has a reducing width to reduce blockage.

17. The system as claimed in claim 7 wherein the opening is located between high and low water levels in the third treatment area.

18. The system as claimed in claim 1 including first pressure means for transferring waste water from the first to the second treatment areas.

19. The system as claimed in claim 18 including second pressure means for transferring waste water from the second to the third treatment area.

20. The system as claimed in claim 19 including a third pressure means for transferring waste water from the third to the first treatment area.

21. The system as claimed in claim 20 including a fourth treatment area with the transfer means configured to transfer waste from the third treatment area to the fourth treatment area.

22. The system as claimed in claim 21 wherein the waste water is transferred from the fourth treatment area to the first treatment area.

23. The system as claimed in claim 1 wherein the transfer means includes one or more conduits connecting the third treatment area with the first treatment area.

24. The system as claimed in claim 1 wherein the first treatment area includes a circulation means for circulating waste water within it.

25. The system as claimed in claim 1 wherein the third treatment area includes a circulation means for circulating waste water within it.

26. The system as claimed in claim 1 wherein the first treatment area is connected to the second treatment area through a first feed means including a conduit and a pump.

27. The system as claimed in claim 1 wherein the second treatment area is connected to the third treatment area through a second feed means.

28. The system as claimed in claim 1 wherein the first treatment area includes a first tank, the second treatment area includes a second tank and the third treatment area includes a third tank.

29. The system as claimed in claim 1 including a control means for controlling waste water entering and leaving the system to maintain the waste water level between upper and lower limits.

30. The system as claimed in claim 29 wherein the control means includes pumps for pumping fluid into and out of the system.

31. The system as claimed in claim 30 wherein the second treatment area maintains a substantially homogenous sludge waste water mix.

32. The system as claimed in claim 31 wherein the first treatment area maintains a substantially homogenous sludge waste water mix.
